(19) United States
(12) Patent Application Publication
(10) Pub. No.: US 2006/0170331 A1
(43) Pub. Date: Aug. 3, 2006

(54) Electroluminescent device with quantum dots

(76) Inventors: Dietrich Bertram, Aachen (DE); Helga Hummel, Aachen (DE); Thomas Justel, Witten (DE)

Correspondence Address: PHILIPS INTELLECTUAL PROPERTY & STANDARDS, P.O. BOX 3001, BRIARCLIFF MANOR, NY, 10510, US

(21) Appl. No.: 10/548,244

(22) PCT Filed: Mar. 1, 2004
(86) PCT No.: PCT/IB04/50171

§ 371 Date: Sep. 6, 2005

(30) Foreign Application Priority Data
Mar. 11, 2003 (EP) 031006018

(51) Int. Cl. H01J 1/62; H01J 63/04

(52) U.S. Cl. 313/498

(57) ABSTRACT

The invention describes an electroluminescent device equipped with a first electrode and a second electrode and with a compressed optical layer with quantum dots, wherein the compressed optical layer emits radiation under the influence of an electrical field. The electroluminescent device in accordance with the invention exhibits increased stability and improved efficiency and brightness.

The invention relates to an electroluminescent device equipped with a first electrode and a second electrode and with an optical layer with quantum dots, wherein the optical layer emits radiation under the influence of an electrical field. The invention also relates to a method of manufacturing an electroluminescent device.

Electroluminescent devices have become enormously important in recent years, and are used, in particular, as display devices or background illumination systems.

The best-known electroluminescent devices currently are conventional LEDs (Light Emitting Diodes) and also OLEDs (Organic Light Emitting Diodes).

In conventional LEDs, the light emission arises from the recombination of electron-hole pairs (excitons) in the transition region of a p-n junction polarized in the conducting direction (semiconductor). The size of the band gap of this semiconductor largely determines the wavelength of the emitted light.

In OLEDs, one (or more) semiconductive, organic layers are arranged between two electrodes. When a voltage is applied to the two electrodes in the conducting direction, electrons migrate from the cathode, and holes from the anode, into the semiconductive organic layer, recombine and generate photons. The wavelength of the emitted light hereby depends on the electronic properties of the organic, semiconductive material.

Also known are inorganic, electroluminescent devices comprising thin films, which, although exhibiting a high degree of stability, have only low efficiency and brightness. The operation of these inorganic electroluminescent devices with alternating current in an order of magnitude of 50 to 100 V gives rise to further problems, such as those associated with EMC or screening, for example.

Especially suitable as light-emitting materials in thin-film electroluminescent devices are quantum dots. Quantum dots are semiconductor nano-particles with a state structure lying between that of molecules and solids. Quantum dots emit light when an electron in the lowest vacant conductive state and a hole in the highest vacant valency state ecombine and emit a photon. The energy of the emitted photon hereby corresponds to the size of the band gap, which, in the case of the quantum dots, is a combination of the band gap of the volume material plus the quantization energy. The latter is determined by the size of the particles. The wavelength of the emitted photon, and thereby the emission color, thus depend directly on the size of the particle. By size variation of the quantum dots, an emission in the ultraviolet, visible or infrared spectral range may be obtained.

In order to stabilize the individual quantum dots, i.e. to prevent agglomeration, organic ligands, such as trioctyl phosphine oxide (TOPO), are applied to the surface. The distance between two quantum dots in a layer is approximately twice the length of the organic ligand. This means that layers with quantum dots exhibit only a low conductivity. The low conductivity has a detrimental effect on light generation in the case of electroluminescent devices which comprise, as the light-emitting layer, a thin film with quantum dots. One disadvantage is that, owing to the low conductivity, the optical layer can only exhibit a, thickness less than 200 nm. In turn, this leads to a diminished robustness of the electroluminescent device, in particular of the optical layer.

It is therefore an object of the present invention to provide an electroluminescent device with high stability, efficiency and brightness, which can be manufactured in large dimensions.

This object is achieved by an electroluminescent device equipped with a first electrode and a second electrode and with a compressed optical layer with quantum dots, wherein the compressed optical layer emits radiation under the influence of an electrical field.

In a compressed optical layer, the quantum dots no longer exhibit organic ligands on their surfaces. As a result, the distance between two quantum dots in the optical layer is reduced. This means that an optical layer of this kind exhibits an increased conductivity and therefore can be manufactured with greater layer thicknesses. A further advantage is that the increased conductivity gives rise to more opportunities, i.e. more design freedom, in the structuring of an electroluminescent device. Overall, the electroluminescent device has greater stability.

The advantageously selected quantum dots as claimed in claims 2 and 3 exhibit good fluorescent properties as a result of the surface modification.

The advantageously selected structure as claimed in claims 4 and 5 ensures that no short-circuits occur in that electrons travel directly from the anode to the cathode through holes between the individual quantum dots.

The advantageously selected structure as claimed in claim 6 ensures that between the quantum dots there are conductive bridges, which improve the charge transfer within the compressed optical layer.

In addition, the invention relates to a method of manufacturing an electroluminescent device, equipped with a first electrode and a second electrode, with a compressed optical layer with quantum dots, wherein, under the influence of an electrical field, the compressed optical layer emits radiation, during which the compressed optical layer is produced in that a layer of quantum dots and particles of a filler material is produced and compressed, wherein the particles of filler material exhibit a smaller diameter than the quantum dots.

Advantageously exploited in this method is the melting point reduction of nano-crystalline materials. Through the exploitation of this effect, the optical layer may be compressed at low temperatures T, mostly at T<300° C. In the compression process, the particles of filler material melt before the quantum dots owing to the melting point reduction, and the filler material is distributed homogeneously between the quantum dots. The finished, compressed optical layer is an enclosed layer comprising the filler material, in which layer the quantum dots are distributed.

The invention will be further described with reference to examples of embodiments shown in the drawings, to which, however, the invention is not restricted.

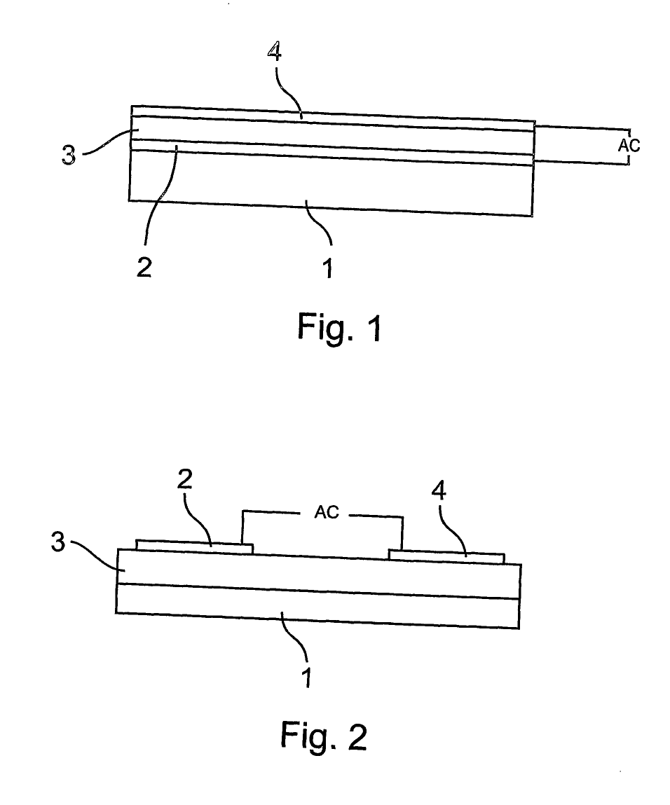

FIG. 1 shows, in cross-section, the structure of an electroluminescent device in accordance with the invention.

FIG. 2 shows, in cross-section, the structure of a further electroluminescent device in accordance with the invention.

In accordance with FIG. 1, a preferred embodiment of the display device in accordance with the invention has a transparent substrate 1, which comprises, for instance, glass or a plastic. Applied to the transparent substrate 1 is a first electrode 2 comprising a transparent, conductive material, such as ITO (indium-doped tin oxide). Located on the first electrode 2 is a compressed optical layer 3. The compressed optical layer 3 comprises quantum dots, which emit light under the influence of an electrical field. Located on the compressed optical layer 3 is a second electrode 4, which preferably comprises a metal, such as silver.

The two electrodes 2, 4 are each provided with electrical terminals and connected to a voltage source.

The electroluminescent device is preferably provided with a protective enclosure comprising a plastic, such as polymethylmethacrylate, for protection, especially against moisture.

FIG. 2 shows a further embodiment of the electroluminescent device in accordance with the invention. In this embodiment, the electroluminescent device is equipped with a substrate to which the compressed optical layer 3 is applied. Applied to the compressed optical layer 3 are the first and second electrodes 2, 4.

Alternatively, the electroluminescent devices may be equipped with still further layers.

The compressed optical layer 3 comprises quantum dots. The quantum dots preferably comprise so-called composite semiconductors, i.e. semiconductors composed of various elements of the main groups from the periodic system. The semiconductor material is, for example, a group IV material, a group III/V material, a group II/VI material, a group I/VII material or a combination of one or more of these semiconductor materials. Preferably, the quantum dots comprise group II/VI materials, such as CdSe, CdS, CdTe, ZnS, HgS, ZnTe, ZnSe or group III/V materials, such as InP, InAs, InN, GaAs, GaN, GaP, GaSb, AlAs or AIP.

Alternatively, the quantum dots may be of a structure such that a quantum dot has a core comprising a semiconductor material, which is surrounded by an inorganic enclosure with a greater band gap. The material of the inorganic enclosure is preferably also a composite semiconductor. Quantum dots of this kind are designated ‘Core Shell Quantum Dots’. Preferred quantum dots with a core shell structure are, for example, CdSe/CdS, CdSe/ZnS, CdTe/CdS, InP/ZnS, GaP/ZnS, Si/ZnS, InN/GaN, InP/CdSSe, InP/ZnSeTe, GaInP/ZnSe, GaInP/ZnS, Si/AIP, InP/ZnSTe, GaInP/ZnSTe or GaInP/ZnSSe.

The diameter of the quantum dots is preferably between 1 and 10 nm. It may, in particular, be preferred that the diameter of the quantum dots is between 1 and 5 nm.

The quantum dots are generally produced by means of colloidal chemistry synthesis. The reaction partners, usually a metal-containing and a non-metal-containing compound, are hereby mixed in an organic solvent or in water, and brought to reaction at elevated temperatures.

To produce quantum dots comprising a core and an inorganic enclosure, the core is firstly produced as described above. The solution is then cooled and one or more pre-stages for the inorganic enclosure are added to the solution. In the case of sulfide-based inorganic enclosures, such as CdS, it is possible to add initially to the solution just one Cd-containing pre-stage, which is then converted into the CdS enclosure with H₂S.

During the precipitation reaction, complexing ligands are added, which adhere to the surface of a quantum dot. In order to improve the size distribution, a size fractionation may subsequently be undertaken.

Preferably used as complexing ligands are organic ligands that evaporate without residue at the compression temperatures. Preferably used as a complexing ligand is pyridine. Alternatively, other complexing ligands, such as hexadecylamine (HAD), trioctyl phosphine oxide (TOPO) and/or trioctyl phosphine (TOP), may be used initially during the synthesis of the quantum dots. Before the compressed optical layer is produced, they are replaced with pyridine by washing multiple times with pyridine.

In this context, compression describes the physical process of uniting particles, namely the quantum dots, at the same time developing the optical layer 3. This may take place by means of heat, pressure, light exposure, chemical reaction or a combination of these means. It is, in particular, preferred for the compression process to take place by means of heat. This process may also be designated the sintering of the optical layer 3.

In order to produce a compressed optical layer 3, the suspension with the stabilized quantum dots is applied to the substrate 1. This may, for instance, take place by repeated immersion of the substrate in the suspension or spin coating. The substrate 1 may already be provided with the first electrode 2.

The optical layer is subsequently compressed at temperatures of up to 300° C. in an inert or reduced atmosphere. The compression temperatures may be reduced on application of an excess pressure during the compression process.

If, in addition to the quantum dots, the compressed, optical layer 3 is to comprise a matrix of a filler material, particles of filler material are added to the suspension with the stabilized quantum dots, wherein the particle diameter of the filler material is smaller than the particle diameter of the quantum dots. The optical layer is then applied to the substrate 1 and compressed, as described above. During the compression process, owing to he melting point reduction of nano-crystalline materials, the particles of filler material melt before the quantum dots, and are distributed homogeneously between the quantum dots. A compressed optical layer 3 is obtained, comprising an enclosed film of the filler material in which the quantum dots are distributed.

The manufacture of the electroluminescent device itself takes place using known methods.

### Example of Embodiment 1

In order to produce an electroluminescent device in accordance with the invention, a suspension of pyridine-stabilized CdSe/ZnS quantum dots is produced in toluol, wherein the CdSe/ZnS quantum dots have a particle diameter of 5 nm. By means of spin coating, a layer of this suspension is applied as the substrate 1 to a glass plate, which has been coated with a first electrode 2 of ITO. The layer structure obtained was compressed in an inert atmosphere for 20 minutes at temperatures of up to 300° C. Following cooling to ambient temperature, the second electrode 4 of Al was applied to the compressed optical layer 3 by means of vapor deposition. The first and second electrodes 2, 4 were provided with electrical terminals and connected to a voltage source. Following application of a voltage greater than 2 V, a light emission in the range of 620 nm was obtained, with a spectrum corresponding to the photoluminescence spectrum of the suspension of CdSe/ZnS quantum dots in toluol.

The electroluminescent device obtained exhibited increased stability and improved efficiency and brightness.

### Example of Embodiment 2

In order to produce an electroluminescent device in accordance with the invention, a suspension of pyridine-stabilized CdSe/CdS quantum dots is produced in trichloromethane, wherein the CdSe/CdS quantum dots have a particle diameter of 5 nm. By means of spin casting, a layer of this suspension is applied to a plastic film as the substrate 1.

The layer structure obtained was compressed at an excess pressure of approximately 1000 bar in an inert atmosphere for 10 minutes at temperatures of up to 150° C. Following cooling to ambient temperature, the first electrode 2 of Al/Au and the second electrode 4 of Al/Au were applied to the compressed optical layer 3 in the form of finger electrodes by means of vapor deposition. The first and second electrodes 2, 4 were provided with electrical terminals and connected to a voltage source. Following application of a voltage greater than 2 V, a light emission in the range of 620 nm was obtained.

The electroluminescent device obtained exhibited increased stability and improved efficiency and brightness.

### Example of Embodiment 3

In order to produce an electroluminescent device in accordance with the invention, a suspension of pyridine-stabilized InP/ZnS quantum dots is produced in toluol, wherein the InP/ZnS quantum dots have a particle diameter of 4 nm. By repeated immersion in the suspension of a glass plate as substrate 1, which was coated with a first electrode 2 of SnO₂:F, a layer of this suspension was applied to the SnO₂:F-coated substrate 1. The layer structure obtained was compressed in an inert atmosphere for 15 minutes at temperatures of up to 300° C. Following cooling to ambient temperature, the second electrode 4 of Au was applied to the compressed optical layer 3. The first and second electrodes 2, 4 were provided with electrical terminals and connected to a voltage source. Following application of a voltage greater than 2.5 V, a light emission in the range of 590 nm was obtained.

The electroluminescent device obtained exhibited increased stability and improved efficiency and brightness.

### Example of Embodiment 4

In order to produce an electroluminescent device in accordance with the invention, a suspension of pyridine-stabilized CdTe quantum dots and ZnS particles with a particle diameter of 2 nm was produced in toluol. By means of spin coating, a layer of this suspension is applied to a glass plate as the substrate 1, which has been coated with a first electrode 2 of ITO. The layer structure obtained was compressed in an inert atmosphere for 20 minutes at temperatures of up to 120° C. Following cooling to ambient temperature, a compressed optical layer 3 of an enclosed film of ZnSe, in which CdTe quantum dots were embedded, was obtained. The second electrode 4 of In/Ni was applied to the compressed optical layer 3 by means of vapor deposition. The first and second electrodes 2, 4 were provided with electrical terminals and connected to a voltage source. Following application of a voltage greater than 3 V, a light emission in the range of 580 nm was obtained.

The electroluminescent device obtained exhibited increased stability and improved efficiency and brightness.

### Example of Embodiment 5

In order to produce an electroluminescent device in accordance with the invention, a suspension of pyridine-stabilized CdSe/CdS quantum dots with a particle diameter of 4.5 nm and CdS particles with a particle diameter of 2 nm was produced in toluol. By means of spin coating, a layer of this suspension is applied to a glass plate as the substrate 1, which has been coated with a first electrode 2 of ITO. The layer structure obtained was compressed in an inert atmosphere for 20 minutes at temperatures of up to 120° C. Following cooling to ambient temperature, a compressed optical layer of an enclosed film of CdS, in which CdSe/CdS quantum dots were embedded, was obtained. The second electrode 4 of in/Ni was applied to the compressed optical layer 3 by means of vapor deposition. The first and second electrodes 2, 4 were provided with electrical terminals and connected to a voltage source. Following application of a voltage greater than 2.8 V, a light emission in the range of 600 nm was obtained.

The electroluminescent device obtained exhibited increased stability and improved efficiency and brightness.

1. An electroluminescent device equipped with a first electrode and a second electrode and with a compressed optical layer with quantum dots, wherein the compressed optical layer emits radiation under the influence of an electrical field.

2. An electroluminescent device as claimed in claim 1, characterized in that a quantum dot comprises a core of a semiconductor material, which is surrounded by an inorganic enclosure with a greater band gap.

3. An electroluminescent device as claimed in claim 2, characterized in that the inorganic enclosure comprises a semiconductor material.

4. An electroluminescent device as claimed in claim 1, characterized in that the compressed optical layer comprises a matrix of a filler material, in which quantum dots are embedded.

5. An electroluminescent device as claimed in claim 4, characterized in that the filler material exhibits a greater band gap than the semiconductor material of a quantum dot of a semiconductor material or the semiconductor material of a quantum dot with a core of a semiconductor material.

6. An electroluminescent device as claimed in claim 5, characterized in that the filler material and the inorganic enclosure comprise the same semiconductor material.

7. A method of manufacturing an electroluminescent device equipped with a first electrode and a second electrode, with a compressed optical layer with quantum layers, which emits radiation under the influence of an electrical field, during which the compressed optical layer is produced in that a layer of quantum dots and particles of a filler material is produced and compressed, wherein the particles of filler material exhibit a smaller diameter than the quantum dots.
